(19) United States
(12) Patent Application Publication
(10) Pub. No.: US 2018/0213559 A1
(43) Pub. Date: Jul. 26, 2018

(54) PACKET RECEIVING METHOD AND RECEIVER FOR DECODING PACKETS OVERLAPPING IN TIME

(71) Applicant: MEDIATEK INC., Hsin-Chu (TW)

(72) Inventors: Ching-Yu Kuo, Hsinchu City (TW); Wei-Chen Wang, Kaohsiung City (TW)

(21) Appl. No.: 15/877,365

(22) Filed: Jan. 22, 2018

Related U.S. Application Data
(60) Provisional application No. 62/449,680, filed on Jan. 24, 2017.

(51) Int. Cl. H04W 74/08; H04L 5/02; H04L 1/00

(52) U.S. Cl. CPC H04W 74/08; H04L 1/0045; H04L 1/0001; H04L 5/02

(57) ABSTRACT

A packet receiving method is provided. The packet receiving method includes the following steps: during receipt of the first packet by a receiver, detecting if any packet arrives at the receiver after a first packet; and when it is detected that a second packet arrives at the receiver during the receipt of the first packet, determining whether to decode the first packet or the second packet.

### CROSS REFERENCE TO RELATED APPLICATIONS

This application claims the benefit of U.S. provisional application No. 62/449,680, filed on Jan. 24, 2017, the contents of which are incorporated herein by reference.

### BACKGROUND

The disclosed embodiments of the present invention relate to packet receiving, and more particularly, to a packet receiving method of a receiver for determining whether to decode an incoming packet during receipt of a packet, and a related receiver.

In a hidden node scenario where there are two nodes cannot hear from each other, the two nodes will send packets to a common node without backoff, resulting in a collision. For example, before receiving process of an earlier packet sent from one of the two nodes in the common node comes to an end, a later packet sent from the other of the two nodes will corrupt the receiving process if the later packet is determined to have a received signal strength indicator (RSSI) value much higher than the earlier packet. The common node therefore cannot successfully receive/decode any of the two packets.

Thus, there is a need for a novel packet receiving/decoding mechanism to avoid packet collisions.

### SUMMARY

In accordance with exemplary embodiments of the present invention, a packet receiving method for determining whether to decode an incoming packet during receipt of a packet, and a related receiver are proposed to solve the above-mentioned problems.

According to an embodiment of the present invention, an exemplary packet receiving method is disclosed. The packet receiving method comprises the following steps: during receipt of the first packet by a receiver, detecting if any packet arrives at the receiver after a first packet; and when it is detected that a second packet arrives at the receiver during the receipt of the first packet, determining whether to decode the first packet or the second packet.

According to an embodiment of the present invention, an exemplary receiver is disclosed. The exemplary receiver comprises a decoder, a packet detector and a control circuit. The decoder is arranged for receiving a first packet. The packet detector is coupled to the decoder, wherein during receipt of the first packet by the decoder, the packet detector detects if any packet arrives at the decoder after a first packet, and accordingly generates a detection result. The control circuit is coupled to the decoder and the packet detector. When the packet detector detects a second packet arrives at the decoder during the receipt of the first packet, the control circuit refers to the detection result to control the decoder to decode one of the first packet and the second packet.

As the proposed packet receiving mechanism may detect if there is a newly arriving packet while receiving an earlier arriving packet, and accordingly decode one of the earlier arriving packet and the newly arriving packet, packet(s) having a higher probability of being correctly decoded can be received preferentially, and packet loss due to collisions can be avoided.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an exemplary wireless communication system according to an embodiment of the present invention.

FIG. 2 is a flow chart of an exemplary packet receiving method according to an embodiment of the present invention.

FIG. 3 is a diagram illustrating an exemplary receiver according to an embodiment of the present invention.

FIG. 4 illustrates a flow chart of an exemplary packet receiving method according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “coupled” is intended to mean either an indirect or direct electrical connection. Accordingly, if one device is electrically connected to another device, that connection may be through a direct electrical connection, or through an indirect electrical connection via other devices and connections.

In order to avoid packet loss due to collisions at a receiver (or a terminal device), the proposed packet receiving mechanism may detect if there are any packets overlapping in time at a receiver (or a terminal device), and keep at least one packet for further processing (e.g. decoding) when it is detected that there are packets overlapping in time, wherein the at least one packet may be, but is not limited to, a portion of the packets which has a higher probability of being correctly decoded by the receiver, is more important to the receiver, or is more likely to be provided for the receiver than the remaining portion of the packets. Please note that the terms “decode” and “decoding” as used herein may refer to operations associated with data extraction, such as but not limited to demodulation, decoding, and/or error correction operations.

For example, the proposed packet receiving mechanism may detect if there is an incoming packet arriving at the receiver while receiving an earlier arriving packet, and accordingly decode one of the earlier arriving packet and the incoming packet. In some embodiments, when a newly arriving packet is detected during a decoding process performed on the earlier arriving packet, the proposed packet receiving mechanism may determine whether to continue decoding the earlier arriving packet or drop the earlier arriving packet in order to decode the newly arriving packet, thus avoiding a situation in which no packet can be successfully received. Further description is provided below.

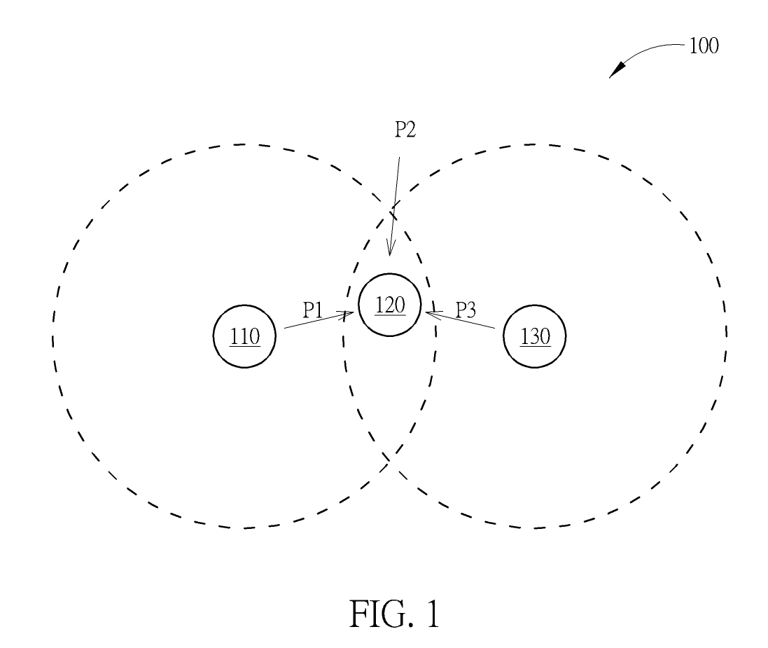

FIG. 1 illustrates an exemplary wireless communication system according to an embodiment of the present invention. The wireless communication system 100 may include a node 110, a node 120 and a node 130, wherein each of the nodes 110, 120 and 130 may be a terminal device such as but not limited to an access point (AP) or a station (STA). In this embodiment, the node 120 may monitor each of packets arriving at the node 120 even if a portion or all of the packets overlap in time, and may keep at least one of the overlapping packets for further processing. For example, while receiving a packet P1 (e.g. sent from the node 110), the node 120 may further detect if another packet arrives before the end of receipt of the packet P1, such as the case when the node 120 detects a remarkable energy increase while receiving the packet P1, thereby decoding one of the packet P1 and the another packet. For more detail, before the node 120 detects the presence of another packet, the node 120 may detect remarkable energy increase caused by the another packet, thus the node 120 can correspondingly determine the presence of the another packet. Hence, in a case where a packet P3 (e.g. sent from the node 130) arrives at the node 120 and is detected by the node 120 during receipt of the packet P1, the node 120 may determine whether to decode the packet P1 or the packet P3.

In some embodiments, when it is determined to decode the packet P1, the node 120 may discard the packet P3 arriving after the packet P1, thus preventing the packet P3 from corrupting the receipt of the packet P1. In some embodiments, when it is determined to decode the packet P3, the node 120 may terminate the receipt of the packet P1 so as to decode the packet P3 preferentially. By way of example but not limitation, when it is determined to decode the packet P3, the node 120 may discard the packet P1 and start to receive (or decode) the packet P3.

Additionally, when detecting that a newly arriving packet (e.g. the packet P3) arrives at the node 120 during receipt of an earlier arriving packet (e.g. the packet P1), the node 120 may refers to reception criteria to determine whether to receive (or decode) the newly arriving packet preferentially, and accordingly determine whether to decode the earlier arriving packet or the newly arriving packet. The reception criteria may include, but is not limited to, whether the newly arriving packet has a higher probability of being correctly decoded by the node 120 than the earlier arriving packet, whether the newly arriving packet is more important to the node 120 than the earlier arriving packet, and/or whether the newly arriving packet is more likely to be provided for the node 120 than the earlier arriving packet. When the newly arriving packet has a higher probability of being correctly decoded by the node 120, is more important to the node 120, and/or is more likely to be provided for the node 120 than the earlier arriving packet, the node 120 may decide to receive (or decode) the newly arriving packet preferentially.

For example, when detecting that the packet P3 arriving during the receipt of the packet P1 has an energy level much higher than an energy level of the packet P1 (a high energy gap), such as the case when the node 120 detects a remarkable energy increase while receiving the packet P1, the node 120 may determine the presence of the packet P3 and the packet P3 has a higher probability of being correctly decoded than the packet P1, thereby deciding to receive (or decode) the packet P3 preferentially. For more detail, before the node 120 detects the presence of the packet P3, the node 120 may detect remarkable energy increase caused by the packet P3, thus the node 120 can correspondingly determine the presence of the packet P3.

It should be noted that the proposed packet receiving mechanism may be employed in a scenario where a newly arriving packet and an earlier arriving packet are of the same communication protocol, and/or employed in a scenario where a newly arriving packet and an earlier arriving packet are of different communication protocols. For example, in a case where the node 120 intending to receive a WiFi packet (e.g. the packet P3) receives a non-WiFi packet (e.g. the packet P1 such as a Bluetooth packet, or a noise-related packet P2 which is a noise signal misidentified as a communication packet) in advance, when detecting that a newly arriving packet (e.g. the packet P3) has an energy level much higher than an earlier arriving packet (e.g. the packet P1 or the noise-related packet P2), the node 120 may decide to receive the newly arriving packet preferentially since the newly arriving packet is more likely to be a WiFi packet than the earlier arriving packet.

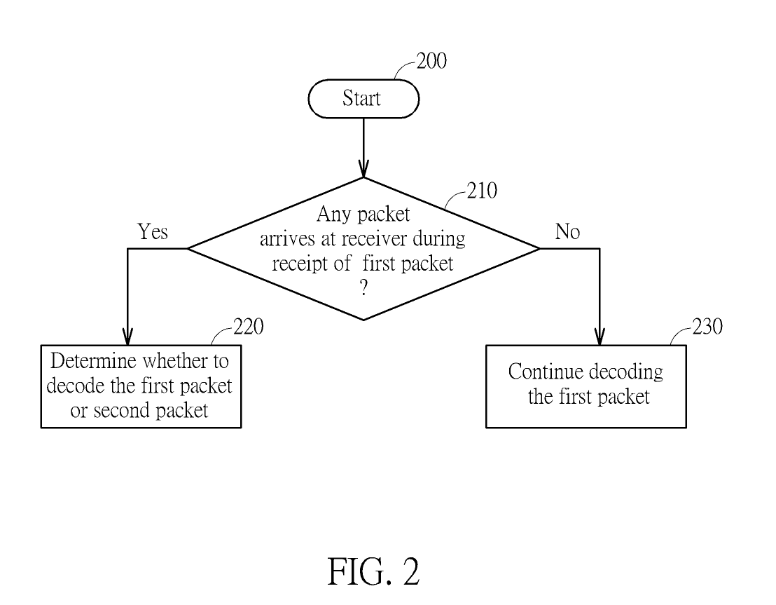

The aforementioned packet receiving mechanism may be summarized in FIG. 2, which is a flow chart of an exemplary packet receiving method according to an embodiment of the present invention. For illustrative purposes, the packet receiving method shown in FIG. 2 is described with reference to the wireless communication system 100 shown in FIG. 1. This is not intended as a limitation of the present invention. It is possible to employ the packet receiving method shown in FIG. 2 in any other wireless communication systems. In addition, provided that the result is substantially the same, steps are not required to be executed in the exact order shown in FIG. 2. For example, steps can be added without departing from the scope of the present invention. The packet receiving method shown in FIG. 2 may be summarized below.

Step 200: Start. For example, the node 120 may start to receive the packet P1 sent from the node 110.

Step 210: During receipt of a first packet by a receiver, detecting if any packet arrives at the receiver after a first packet. If yes, go to step 220; otherwise, go to step 230. For example, at least part of the node 120 may be implemented by a receiver. During receipt of the packet P1, the node 120 may detect if any packet arrives thereat after the packet P1.

Step 220: When it is detected that a second packet arrives at the receiver during the receipt of the first packet, determine whether to decode the first packet or the second packet. For example, when the node 120 detects that the packet P3 arrives during the receipt of the packet P1, the node 120 may further determine whether to decode the packet P1 or the packet P3.

Step 230: When it is detected that no packet arrives at the receiver during the receipt of the first packet, continue receiving or decoding the first packet. For example, when detecting that no packet arrives during the receipt of the packet P1, the node 120 may continue receiving or decoding the packet P1.

In step 220, the packet receiving method may refers to reception criteria to determine whether to receive (or decode) the second packet preferentially, wherein the reception criteria may include, but is not limited to, whether the second packet has a higher probability of being correctly decoded by the receiver than the first packet, whether the second packet is more important to the receiver than the first packet, and/or whether the second packet is more likely to be provided for the receiver than the first packet. For example, when an energy level of the packet P3 satisfies a predetermined criterion (e.g. much higher than an energy level of the packet P1), the node 120 may decide to receive the packet P3 preferentially since the packet P3 may have a higher probability of being correctly decoded than the packet P1.

Additionally, in some embodiments, when it is determined to decode the second packet (e.g. the packet P3), the packet receiving method may further terminate the receipt of the first packet (e.g. the packet P1). In some embodiments, when it is determined to decode the first packet (e.g. the packet P1), the packet receiving method may further discard the second packet (e.g. the packet P3).

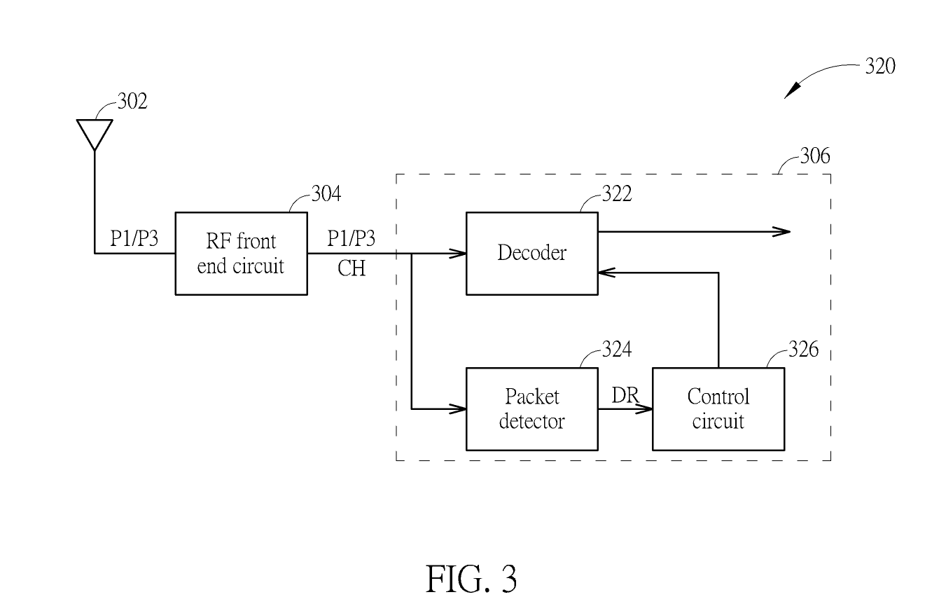

To facilitate an understanding of the present invention, an exemplary circuit implementation is given in the following for further description of the proposed packet receiving mechanism. It should be noted that other circuit implementations employing the packet receiving method shown in FIG. 2 are feasible. Please refer to FIG. 3 in conjunction with FIG. 1. FIG. 3 is a diagram illustrating an exemplary receiver 320 according to an embodiment of the present invention, wherein at least part of the node 120 shown in FIG. 1 may be implemented by the receiver 320. In other words, the node 120 shown in FIG. 1 may include or may be implemented by the receiver 320 shown in FIG. 3.

In this embodiment, the receiver 320 may include, but is not limited to, an antenna 302, a radio frequency (RF) front end circuit 304 and a baseband processing circuit 306. When a packet (e.g. the packet P1, the packet P3 or the noise-related packet P2) arrives at the node 120, the antenna 302 may receive the packet, the RF front end circuit 304 may preprocess (e.g. filter, amplify and/or convert) the packet received at the antenna 302, and the baseband processing circuit 306 may decode the packet which has been preprocessed by the RF front end circuit 304. For example, when the packet P1 sent from the node 110 arrives at the node 120, the RF front end circuit 304 may preprocess the packet P1 received at the antenna 302, and the baseband processing circuit 306 may start to decode the packet P1 which has been preprocessed by the RF front end circuit 304.

The baseband processing circuit 306 may include, but is not limited to, a decoder 322, a packet detector 324 and a control circuit 326. The decoder 322 may receive the packet transmitted from the RF front end circuit 304 (e.g. the packet P1, the packet P3 or the noise-related packet P2). The packet detector 324 is coupled to the decoder 322, wherein during receipt of the packet, the packet detector 324 may detect if any packet arrives at the decoder 322 after the packet, and accordingly generate a detection result DR. The control circuit 326 is coupled to the decoder 322 and the packet detector 324, and may refer to the detection result DR to control a decoding process of the decoder 322.

For example, when the packet detector 324 detects that a newly arriving packet arrives at the decoder 322 (or the receiver 320) during the receipt of the packet (i.e. an earlier arriving packet), the control circuit 326 may refer to the detection result DR to control the decoder 322 to decode one of the earlier arriving packet and the newly arriving packet. In some embodiments, when the control circuit 326 refers to the detection result DR to control the decoder 322 to decode the newly arriving packet, the control circuit 326 may control the decoder 320 to terminate the receipt of the earlier arriving packet. In some other embodiments, when the control circuit 326 refers to the detection result DR to control the decoder 322 to decode the earlier arriving packet, the control circuit 326 may control the decoder 320 to discard (or not to receive) the newly arriving packet.

Please note that the packet detector 324 may utilize various detection strategies to detect if any packet arrives during the receipt of the earlier arriving packet. In one exemplary design where the packet P1 (an earlier arriving packet) arrives at the decoder 322 (or the receiver 320) via a channel CH, the packet detector 324 may monitor an energy level of the channel CH to detect if any packet arrives at the decoder 320 during the receipt of the packet P1, and accordingly generate the detection result DR. When the detection result DR indicates that the energy level of the channel CH is greater than a predetermined threshold during receipt of the packet P1, it is determined that a newly arriving packet (e.g. the packet P3) arrives at the decoder 322 during receipt of the packet P1.

In one embodiment, before the packet detector 324 detects the presence of the packet P3, the packet detector 324 may detect remarkable energy increase of the channel CH caused by the packet P3 while receiving the packet P1, thus the packet detector 324 can correspondingly determine the presence of the packet P3.

In another exemplary design where the packet P1 (an earlier arriving packet) arrives at the decoder 322 (or the receiver 320) via the channel CH, the packet detector 324 may perform preamble detection in the channel CH to detect if any packet arrives at the decoder 322. For example, the packet detector 324 may run a correlation test in the channel CH to generate the detection result DR, wherein when the detection result DR indicates that a short channel field (STF) is detected, it is determined that a newly arriving packet (e.g. the packet P3) arrives at the decoder 322 during receipt of the packet P1.

In addition, when the packet detector 324 detects that the packet P3 (a newly arriving packet) overlaps with the packet P1 (an earlier arriving packet) in time at the receiver 320, the detection result DR generated by the packet detector 324 may further indicate an energy level of the packet P3. For example, in one exemplary design where the packet detector 324 monitors an energy level of the channel CH to detect that the packet P3 arrives or will arrive during the receipt of the packet P1, the energy level of the channel CH may be regarded as the energy level of the packet P3. In another exemplary design where the packet detector 324 performs preamble detection (e.g. STF detection) in the channel CH to detect that the packet P3 arrives during the receipt of the packet P1, the energy level of the packet P3 may be estimated/obtained from a preamble of the packet P3 (e.g. STF field).

Hence, the control circuit 326 may refer to the detection result DR to determine whether the energy level of the packet P3 satisfies a predetermined criterion. When the energy level of the packet P3 satisfies the predetermined criterion, the control circuit 326 may control the decoder 322 to decode the packet P3. When the energy level of the packet P3 does not satisfy the predetermined criterion, the control circuit 326 may control the decoder 322 to decode the packet P1.

By way of example but not limitation, the predetermined criterion may be whether the energy level of the packet P3 exceeds an energy level of the packet P1 by more than a predetermined level (e.g. a noise tolerance level). When the energy level of the packet P3 exceeds the energy level of the packet P1 by more than the predetermined level (i.e. a sufficiently high energy rise is detected during the receipt of the packet P1), the control circuit 326 may determine that the packet P3 has a higher probability of being correctly decoded than the packet P1, thereby determining that the predetermined criterion is satisfied.

The above is for illustrative purposes only, and is not intended to limit the present invention. For example, the control circuit 326 may refer to other packet information indicated by the detection result DR to control the decoder 322 whether to receive a newly arriving packet preferentially. In another example, the baseband processing circuit 306 may be implemented using other structures. In yet another example, the proposed packet receiving mechanism may be implemented in a stage other than a baseband stage. In brief, as long as a newly arriving packet may be monitored/detected during receipt of an earlier arriving packet, and either the newly arriving packet or the earlier arriving packet may be accordingly received, various modifications and alternatives fall within the scope of the present invention.

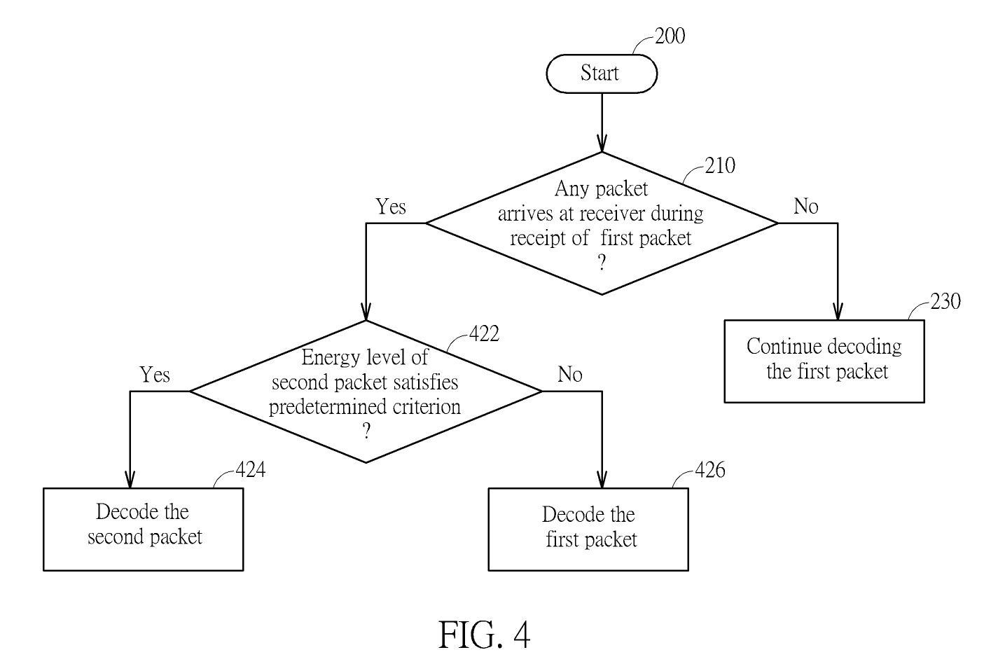

The proposed packet receiving mechanism utilizing energy information to determine whether to receive/decode a newly arriving packet preferentially may be summarized in FIG. 4. FIG. 4 illustrates a flow chart of an exemplary packet receiving method according to an embodiment of the present invention. The packet receiving method shown in FIG. 4 is based on the packet receiving method shown in FIG. 2, wherein the main difference is that the packet receiving method shown in FIG. 4 refers to packet energy to determine whether to decode an earlier arriving packet or a newly arriving packet. For illustrative purposes, the packet receiving method shown in FIG. 4 is described with reference to the receiver 320 shown in FIG. 3. Provided that the result is substantially the same, the steps are not required to be executed in the exact order shown in FIG. 4. Other intermediate steps can be added. The packet receiving method shown in FIG. 4 may be summarized below.

Step 200: Start. For example, the receiver 320 may start to receive the packet P1.

Step 210: During receipt of a first packet by a receiver, detecting if any packet arrives at the receiver after a first packet. If yes, go to step 422; otherwise, go to step 230. For example, during receipt of the packet P1, the receiver 320 may detect if any packet arrives thereat after the packet P1.

Step 422: When it is detected that a second packet arrives at the receiver during the receipt of the first packet, determine whether an energy level of the second packet satisfies a predetermined criterion. If yes, go to step 424; otherwise, go to step 426. For example, when the packet detector 324 detects that the packet P3 arrives at the decoder 322 during the receipt of the packet P1, the control circuit 326 may refer to the detection result DR to determine whether the energy level of the packet P3 satisfies a predetermined criterion, such as whether the energy level of the packet P3 exceeds the energy level of the packet P1 by more than a predetermined level.

Step 424: Decode the second packet. For example, the control circuit 320 may control the decoder 322 to terminate the receipt of the packet P1 and decode the packet P3 preferentially.

Step 426: Decode the first packet. For example, the control circuit 320 may control the decoder 322 to continue decoding the packet P1 and discard (or not to receive) the packet P3.

Step 230: Continue receiving or decoding the first packet. For example, when the packet 324 detects that no packet arrives during the receipt of the packet P1, the decoder 322 may continue receiving or decoding the packet P1.

As one skilled in the art should understand operations associated with the packet receiving method shown in FIG. 4 after reading the above paragraphs directed to FIGS. 1-3, further description is omitted here for brevity.

To sum up, as the proposed packet receiving mechanism may detect if there is a newly arriving packet while receiving an earlier arriving packet, and accordingly decode one of the earlier arriving packet and the newly arriving packet, packet(s) having a higher probability of being correctly decoded can be received preferentially, and packet loss due to collisions can be avoided.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A packet receiving method, comprising:
during receipt of a first packet by a receiver, detecting if any packet arrives at the receiver after the first packet; and
when it is detected that a second packet arrives at the receiver during the receipt of the first packet, determining whether to decode the first packet or the second packet.

2. The packet receiving method of claim 1, wherein the step of determining whether to decode the first packet or the second packet comprises:
determining whether an energy level of the second packet satisfies a predetermined criterion;
when the energy level of the second packet satisfies the predetermined criterion, decoding the second packet; and
when the energy level of the second packet does not satisfy the predetermined criterion, decoding the first packet.

3. The packet receiving method of claim 2, wherein when the energy level of the second packet exceeds an energy level of the first packet by more than a predetermined level, it is determined that the predetermined criterion is satisfied.

4. The packet receiving method of claim 1, wherein when it is determined to decode the second packet, the packet receiving method further comprises:
terminating the receipt of the first packet.

5. The packet receiving method of claim 1, wherein when it is determined to decode the first packet, the packet receiving method further comprises:
discarding the second packet.

6. The packet receiving method of claim 1, wherein the receiver receives the first packet via a channel; and the step of detecting if any packet arrives at the receiver after the first packet comprises:
monitoring an energy level of the channel to detect if any packet arrives at the receiver.

7. The packet receiving method of claim 1, wherein the receiver receives the first packet via a channel; and the step of detecting if any packet arrives at the receiver after the first packet comprises:
performing a preamble detection in the channel to detect if any packet arrives at the receiver.

8. A receiver, comprising:
a decoder, for receiving a first packet;
a packet detector, coupled to the decoder, wherein during receipt of the first packet by the decoder, the packet detector detects if any packet arrives at the decoder after a first packet, and accordingly generates a detection result; and
a control circuit, coupled to the decoder and the packet detector, wherein when the packet detector detects that a second packet arrives at the decoder during the receipt of the first packet, the control circuit refers to the detection result to control the decoder to decode one of the first packet and the second packet.

9. The receiver of claim 8, wherein the detection result indicates an energy level of the second packet, and the control circuit refers to the detection result to determine whether the energy level of the second packet satisfies a predetermined criterion; when the energy level of the second packet satisfies the predetermined criterion, the control circuit controls the decoder to decode the second packet; and when the energy level of the second packet does not satisfy the predetermined criterion, the control circuit controls the decoder to decode the first packet.

10. The receiver of claim 9, wherein when the energy level of the second packet exceeds an energy level of the first packet by more than a predetermined level, the control circuit determines that the predetermined criterion is satisfied.

11. The receiver of claim 8, wherein when the control circuit refers to the detection result to control the decoder to decode the second packet, the control circuit further controls the decoder to terminate the receipt of the first packet.

12. The receiver of claim 8, wherein when the control circuit refers to the detection result to control the decoder to decode the first packet, the control circuit further controls the decoder to discard the second packet.

13. The receiver of claim 8, wherein the first packet arrives at the decoder via a channel, and the packet detector monitors an energy level of the channel to detect if any packet arrives at the decoder.

14. The receiver of claim 8, wherein the first packet arrives at the decoder via a channel, and the packet detector performs preamble detection in the channel to detect if any packet arrives at the decoder.
